(19) United States
(12) Patent Application Publication
(10) Pub. No.: US 2024/0107933 A1
(43) Pub. Date: Apr. 4, 2024

(54) PLANTING MACHINE AND METHOD OF MEASURING PLANTING SEED RATE

(71) Applicant: DEERE & COMPANY, Moline, IL (US)

(72) Inventors: Bryan E. Dugas, Thibodaux, LA (US); Mark S. Louviere, Houma, LA (US); Jeffrey J. Simoneaux, Gonzales, LA (US); Jesse D. Lopez, Thibodaux, LA (US); Felipe D. Dias, Indaiatuba (BR)

(21) Appl. No.: 18/348,932

(22) Filed: Jul. 7, 2023

Related U.S. Application Data
(60) Provisional application No. 63/412,355, filed on Sep. 30, 2022.

(51) Int. Cl. A01C 11/00; G06T 7/285; G06V 20/10

(52) U.S. Cl. CPC A01C 11/006; G06T 7/285; G06V 20/188; G06T 2200/04; G06T 2207/10021; G06T 2207/30188; G06T 2207/30242

(57) ABSTRACT

A system for measuring crop seed rate of a planting machine, the system including a camera having a first field of view through which crop material may pass, and one or more electronic controllers in operable communication with the camera and the planting machine. The one or more electronic controls are configured to receive image data from the camera, identify one or more attributes of the crop material positioned in the field of view of the camera, determine a speed associated with the planting machine, determine a current crop seed rate of the planting machine based at least in part on the one or more attributes of the crop material in the field of view and the speed of the planting machine, and output one or more recommended operating conditions to the planting machine based at least in part on the determined crop seed rate.

### CROSS-REFERENCE TO RELATED APPLICATIONS

The present application claims the benefit of co-pending U.S. Provisional Patent Application No. 63/412,355, filed Sep. 30, 2022. The entire contents of which are incorporated by reference herein.

### BACKGROUND

Planting machines typically include various inputs that allow the user to manually modify the volume and manner in which crop material is deposited on the ground.

### SUMMARY

In one aspect a system for measuring crop seed rate of a planting machine, the system including a camera having a first field of view through which crop material may pass, and one or more electronic controllers in operable communication with the camera and the planting machine, where the electronic controllers are configured to receive image data from the camera, identify one or more attributes of the crop material positioned in the field of view of the camera, determine a speed associated with the planting machine, determine a current crop seed rate of the planting machine based at least in part on the one or more attributes of the crop material in the field of view and the speed of the planting machine, and output one or more recommended operating conditions to the planting machine based at least in part on the determined crop seed rate.

Alternatively or additionally, in any combination, where identifying one or more attributes of the crop material includes identifying at least one of the number of billets in the field of view, the number of nodes in the field of view, and the number of eyes in the field of view.

Alternatively or additionally, in any combination, where the one or more electronic controllers compare the current crop seed rate to a target crop seed rate to determine a crop seed rate difference, and where the one or more electronic controllers output the one or more recommended operating conditions based at least in part on the crop seed rate difference.

Alternatively or additionally, in any combination, where the one or more controllers have memory, where the one or more controllers store past crop seed rate data in the memory, and where the one or more controllers determine the current crop seed rate based at least in part on the past crop seed rate data.

Alternatively or additionally, in any combination, where outputting one or more recommended operating conditions to the planting machine includes outputting a suggested travel speed.

Alternatively or additionally, in any combination, where the electronic controller collects location data associated with a path the planter traverses in a defined area, and generates an overlay for a map of the defined area based on the location data, the seed feed rate of the planting machine, and the amount of nodes.

Alternatively or additionally, in any combination, further comprising a second camera having a second field of view, and where the one or more controllers are in operable communication of the second camera.

Alternatively or additionally, in any combination, where the first camera and the second camera produce a three-dimensional image.

In another aspect, a method for measuring seed feed rate of a planting machine, the method including receiving image data from a camera of a planting machine, the image data including an image of a crop material in a target region of the planting machine, receiving a target seed feed rate from one of memory and the user, determining an attribute associated with the crop material in the target region of the planter, determining a travel speed associated with the planting machine, determining a current seed feed rate of the planting machine based on the attribute associated with the crop material in the target region and the speed associated with the planting machine, and transmitting one or more target operating conditions to the planting machine based at least in part on the current seed feed rate and the target seed feed rate.

Alternatively or additionally, in any combination, where transmitting one or more target operating conditions includes transmitting a target travel speed.

Alternatively or additionally, in any combination, where receiving image data from a camera includes receiving three-dimensional image data.

Alternatively or additionally, in any combination, where determining an attribute associated with the crop material in the target region includes at least one of determining the number of billets present in the target region, determining the number of nodes in the target region, and determining the number of eyes in the target region.

Alternatively or additionally, in any combination, where determining an attribute associate with the crop material in the target region includes determining one or more attributes of an individual billet within the target region.

Alternatively or additionally, in any combination, determining one or more attributes of an individual billet includes determining at least one of the billet length, the number of nodes on the billet, and the number of eyes on the billet.

Alternatively or additionally, in any combination, determining one or more attributes of an individual billet includes calculating the attribute based at least in part on a pre-determined virtual billet model.

Alternatively or additionally, in any combination, further comprising calculating one or more bulk billet attributes based at least in part on the attributes associated with the crop material in the target region.

Alternatively or additionally, in any combination, where determining the current seed feed rate is at least partially dependent upon the bulk billet attributes.

Alternatively or additionally, in any combination, transmitting one or more target operating conditions includes increasing and decreasing the seed distribution rate.

In another aspect, a planting machine including a hopper, a planting chute, a metering device configured to output crop material at a pre-determined rate to the planting chute, a camera having a first field of view configured to capture crop material that is distributed from the metering device, and one or more controllers in operable communication with the hopper, planting chute, metering deice, and camera, wherein the controller, receives video data from the camera, identifies one or more attributes of the crop material traveling through the first field of view, calculates the travel speed of the planting machine, calculates the crop seed rate of the planting machine based at least in part on the travel speed and one or more attributes of the crop material, and outputs commands to the metering device to increase or decrease the pre-determined rate based at least in part on the calculated crop seed rate.

Alternatively or additionally, in any combination, where the one or more attributes of the crop material may include the number of billets present, the number of nodes present, and the number of eyes present.

### BRIEF DESCRIPTION OF THE DRAWINGS

FIG. 1A is a perspective view of a planting machine according to one embodiment.

FIG. 1B is a top view of the planting machine of FIG. 1A according to one embodiment.

FIG. 1C illustrates a side view of the planting machine of FIG. 1A according to one embodiment.

FIG. 1D illustrates a sugarcane billet of the crop material of the planting machine of FIG. 1A according to one embodiment.

FIG. 2 is a block diagram of a control system for measuring crop seed feed rate of a planting machine and managing planting quality of the planting machine of FIG. 1A according to one embodiment.

FIG. 3 is a flowchart of a method of measuring crop seed feed rate of a planting machine and managing planting quality of the planting machine using the system of FIG. 2 according to one embodiment.

FIG. 4 is a view of a target area taken from a camera with crop material deposited on the surface of a field.

FIG. 5 illustrates a display with a map overlay depicted thereon.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

Various embodiments of the present invention disclose a system that allows users to establish a desired target planting rate envelope for crop material (e.g., a crop seed rate) by a planting machine and monitor the planting performance of the planting machine. In some implementations, the system determines when the crop seed rates fall outside the established envelope and generates recommendations to correct the performance of the planting machine at least partially in response thereto.

Embodiments of the present invention recognize that challenges exist in existing open loop control scheme systems that monitor plant/seed rates. Seed rates are set based on ground speed and an estimated tons per acre guidelines from previous plant seasons. Seed rates effect plant population, crop yield, and sugar yield in sugarcane cultivation. Existing crop advancement devices are set and the crop material is delivered to a metering device with a pre-determined feed rate whereby the crop material is dumped into multiple hoppers or troughs for disbursement. The ability to document, adjust and maintain an optimum seed or node rate and placement helps maximize efficiency and minimize overall cost of sugarcane cultivation. Various embodiments of the present device provide a mechanism that utilizes inputs and/or parameters, such as, final metering rate at hopper discharge, billet feed rate assembly to the metering device, ground speed, hopper volume, and available billet crop in storage area to adjust metering and billet feed rates. The mechanism indicates issues with performance of specific devices of the planting machine. Also, embodiments of the present invention utilize vehicle GPS data, vehicle speed, planter location and GPS to provide a near real-time performance map of metrics associated with planting rates of the planting machine during operation.

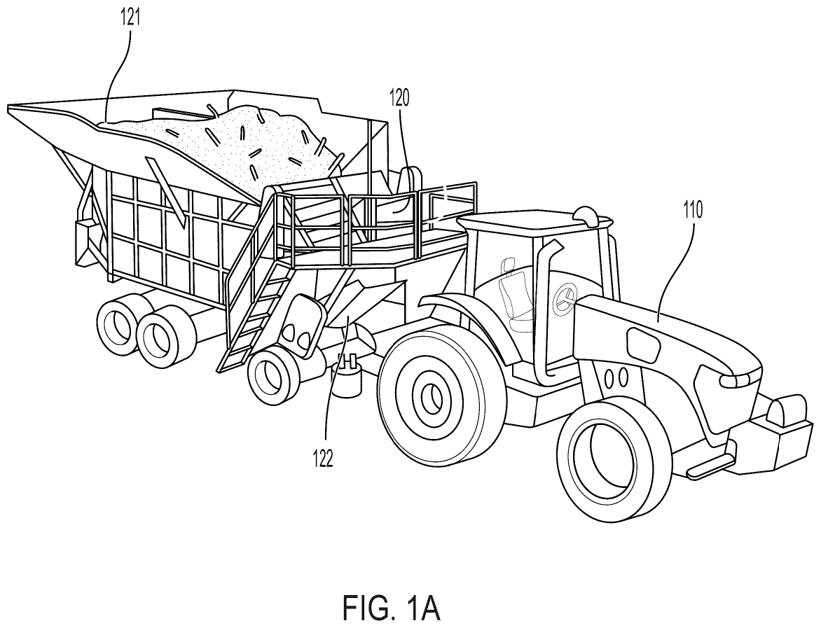

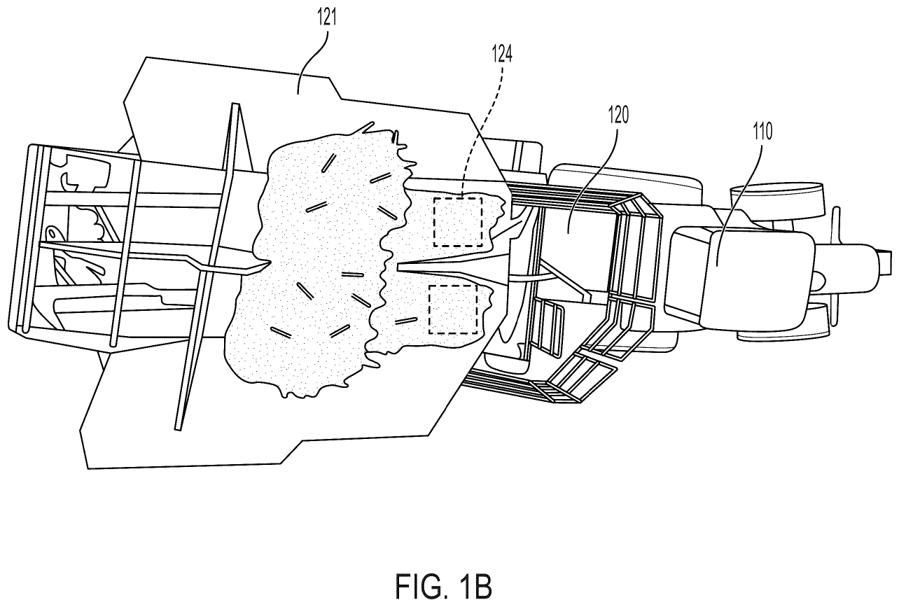

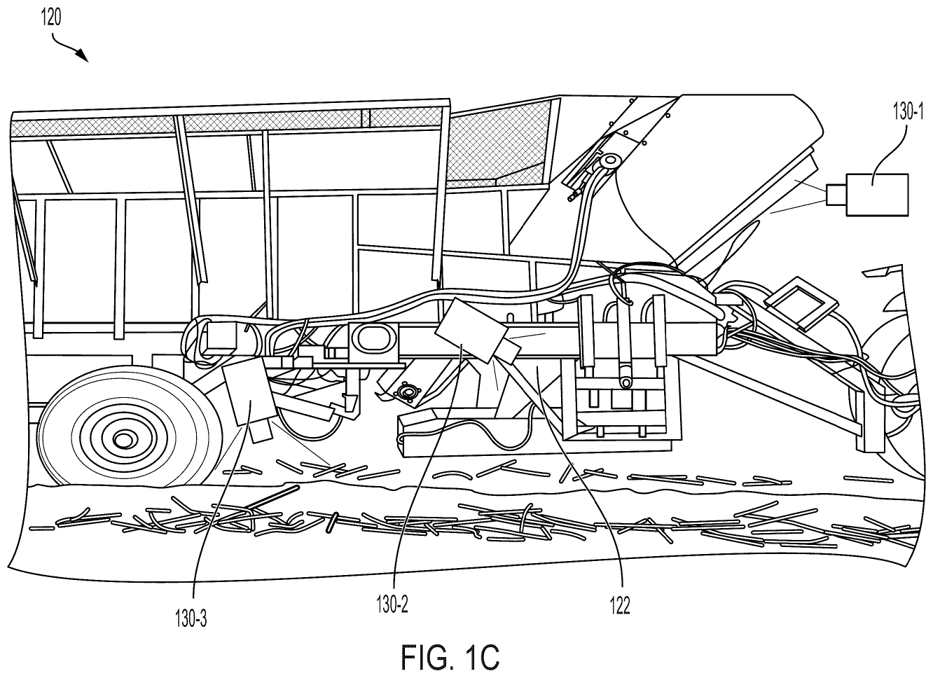

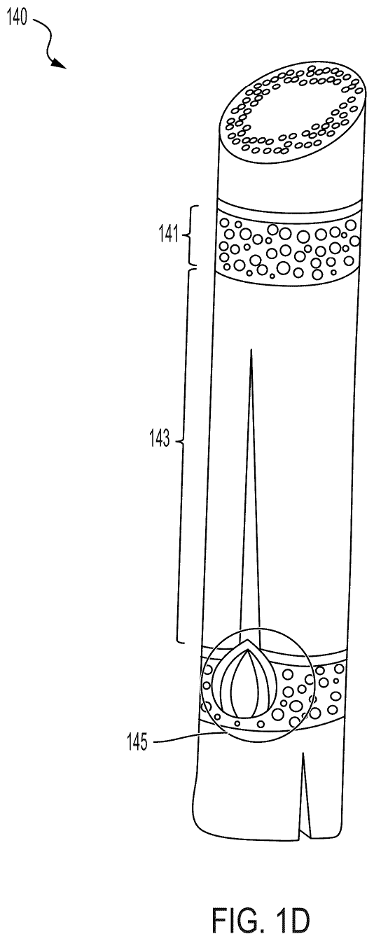

FIG. 1A illustrates an example of a planting machine 120 that is pulled by a tractor 110 during operation. In this example, the planting machine 120 is physically and communicatively coupled to the tractor 110 such that the tractor 110 is configured to pull the planting machine 120 across the field during operation. While the illustrated planting machine 120 is pulled by the tractor 110, it is understood that in other embodiments the planting machine 120 may be self-propelled.

The planting machine 120 includes a hopper 121, a meter device 124, and a planting chute 122. The hopper 121 is a container for storing bulk crop material such as, for example, sugarcane billets 140 (discussed below). The hopper 121, in turn, is configured to feed the crop material to the metering mechanism (e.g., see meter device 124 of FIG. 1B) whereby the metering mechanism 124 dispenses or outputs the crop material at a pre-determined rate to the planting chute 122. The planting chute 122 is then configured to discharge and distribute the crop material output by the metering mechanism 124 on to a surface of a field in a pre-determined pattern or manner. For example, in some implementations, as the planting machine 120 is pulled across a field surface the planting machine 120 opens a trench (or furrow) and the planting chute 122 deposits the crop material from the hopper 121 into the trench, and, in some cases, closes the trench. Although the example of FIG. 1 shows a single planting chute 122, in other implementations, the planting machine 120 may include more than one planting chute 122. In still other embodiments, the planting machine 120 may include multiple independently controlled planting assemblies, with each assembly having an independently controlled metering mechanism and planting chute 122 while being pulled at a common speed by a single tractor 110.

FIG. 1B illustrates a top view of an example of the planting machine 120 that is pulled by the tractor 110 during operation. In this example, the planting machine 120 includes a meter device 124. The meter device 124 is configured to receive crop material from the hopper 121 and dispense the crop material into the planting chute 122 at predetermined rate. For example, in some embodiments, the meter device 124 is configured to deliver crop material to the planting chute 122 at a rate based on a speed of a motor of the meter device 124. The hopper 121, in turn, is configured to feed the crop material to the meter device 124 based on the operating condition of the hopper's control valve. In some implementations, the hopper 121 includes a moveable wall or other form of control valve that is able to influence the rate at which crop material is fed to the meter device 124.

FIG. 1C illustrates a side view of an example of the planting machine 120 that is pulled by the tractor 110 during operation. In this example, the planting machine 120 includes camera 130-1, camera 130-2, and camera 130-3. The camera(s) 130 each includes a field of view configured to capture video data that includes identifying and tracking individual elements and attributes of crop material that is distributed during operation of the planting machine 120 and is subsequently planted. In some embodiments, the cameras 130 are positioned so that all crop material distributed by the planting machine 120 will pass through the field of view of at least one camera. In other embodiments, the cameras 130 may be positioned so that a known proportion (e.g., 25%, 50%, 75%) of the volume of crop material distributed by the planting machine 120 will pass through the field of view of at least one camera.

For example, the camera 130-1 is disposed above the planting machine 120 with a field of view that captures crop material fed from the hopper 121 to the meter device 124 and/or dispensed from the meter device 124 to the planting chute 122. In another example, the camera 130-2 is disposed below the planting machine 120 with a field of view that captures crop material in a target region of the planting chute 122. In another example, the camera 130-3 is disposed below the planting machine 120 with a field of view that captures crop material discharged from the planting chute 122 onto a surface of a field. In some embodiments, the camera(s) 130 are mounted above the planting chute 122. For example, in such embodiments the camera 130 is positioned centered across a width of the planting chute 122. As a result, of the centered position the camera(s) 130 eliminate or reduce bias with respect to uneven shape of the crop material. In some implementations, two or more instances of the camera(s) 130 can be mounted in a common housing to ensure relative placement.

While the illustrated planting machine 120 includes three cameras 130-1, 130-2, 130-3 positioned as described above, it understood in other embodiments more or fewer cameras 130 may be present. For example, multiple cameras monitoring the operation of the meter device 124 to identify and record each billet 140 that passes therethrough during operation. In still other embodiments, one or more cameras 130 may be present to identify and record each billet 140 that slides down and is distributed by the planting chute 122. In still other embodiments the cameras 130 may be mounted remotely from the planting machine 120 such as, but not limited to, on the tractor 110, on a separately driven truck or tractor (not shown), and/or be mounted to a separate trailer being pulled behind the planting machine 120.

In some embodiments, the camera(s) 130 are calibrated based on a mounting location of the camera. During this calibration process, the planting chute or discharge area back plate is located, and a floor plane are determined and measured. For example, calibration variables can include the distance of a camera to a part or component of the planting machine 120, tilt angle of the camera with respect to a discharge plane, lighting, environmental conditions, etc. Positioning and tilting the camera accordingly may increase the image quality. LED lighting options will be supported for low light conditions and/or nighttime operation of the camera(s) 130. For example, the lighting system can allow the planting machine 120 to operate during nighttime by illuminating a field of view of the camera(s) 130 when ambient light in the field of view is low to absent. Additionally, lighting system can also modify the exposure time of the camera(s) 130 to reduce or eliminate motion blur when the crop material travels at a high rate of speed. In some implementations, the camera(s) 130 are self-calibrating (e.g., auto-focus, light settings, etc.) to account for environmental conditions, such as, dust, over-exposure, and the like.

FIG. 1D illustrates an example of a sugarcane billet 140 of crop material of the planting machine 120 that is planted during operation thereof. Each billet 140, in turn, includes one or more nodes 141, one or more internodes 143 extending between adjacent nodes 141, and one or more eyes 145 positioned on a corresponding node 141. Together, the nodes 141, internodes 143, and eyes 145 of each individual billet 140 defines a plurality of individual billet attributes that are associated with a single billet 140 and that are able to be detected and/or calculated by the controller 201 (discussed below). Such individual attributes may include, but are not limited to, the overall billet length (e.g., the distance between the two distal ends of the billet 140), the internodal length (e.g., the length between a particular set of adjacent nodes 141), the average internodal length (e.g., the average of all internodal lengths found on an individual billet 140), the node number (e.g., the number of nodes 141 found on a particular billet 140), the eye number (e.g., the number of eyes 145 found on a particular billet 140), the billet diameter (e.g., the average diameter of a particular billet 140), and the like.

In addition to individual billet attributes, the controller 201 may also be configured to compile the detected individual attributes discussed above to calculate one or more bulk billet attributes generally applicable to the volume of billets distributed during a pre-selected interval of operation of the planting machine 120. Such bulk attributes may include, but are not limited to, an average bulk billet length, an average bulk internodal length, an average bulk node number, an average bulk eye number, an average billet age, and the like. When determining bulk attributes or applying bulk attributes to a new billet 140, the controller 201 may also take into account the age of the billets 140 to match the billets 140 to a pre-determined virtual billet model that is saved in memory (e.g., anticipated individual or bulk attributes based on the age of the plant from which the billets were harvested). Such a pre-determined virtual billet model may include data previously uncovered for the area or field currently being worked and/or be more universal for a particular region, country, plant species, and the like. In still other embodiments, the virtual billet model may be a weighted combination of the above depending on user inputs wanting to emphasize and de-emphasize various features.

The eye 145 of a billet 140 is a seed that is disposed in a node 141 thereof. In some embodiments, physical appearance (e.g., color, shape, texture, length, etc.) of the billet 140 is utilized to count the number of the billets 140 and/or the eyes 145 discharged from the planting machine 120. In some embodiment, when image quality of video data is degraded due to environmental conditions (e.g., low lighting, dust, over exposure, or the like) the physical appearance of the billet 140 is utilized to estimate the number of the billets 140 and/or the eyes 145 discharged from the planting machine 120 for the portions of the image that are affected by the environmental conditions (e.g., relying at least in part upon the bulk billet data and/or the virtual billet model, discussed above). Additionally, the physical appearance of the billet 140 is utilized to estimate the number of the billets 140 and/or the eyes 145 discharged from the planting machine 120 for crop material that cannot be captured due to density of the plurality of billets 140 captured in the video data.

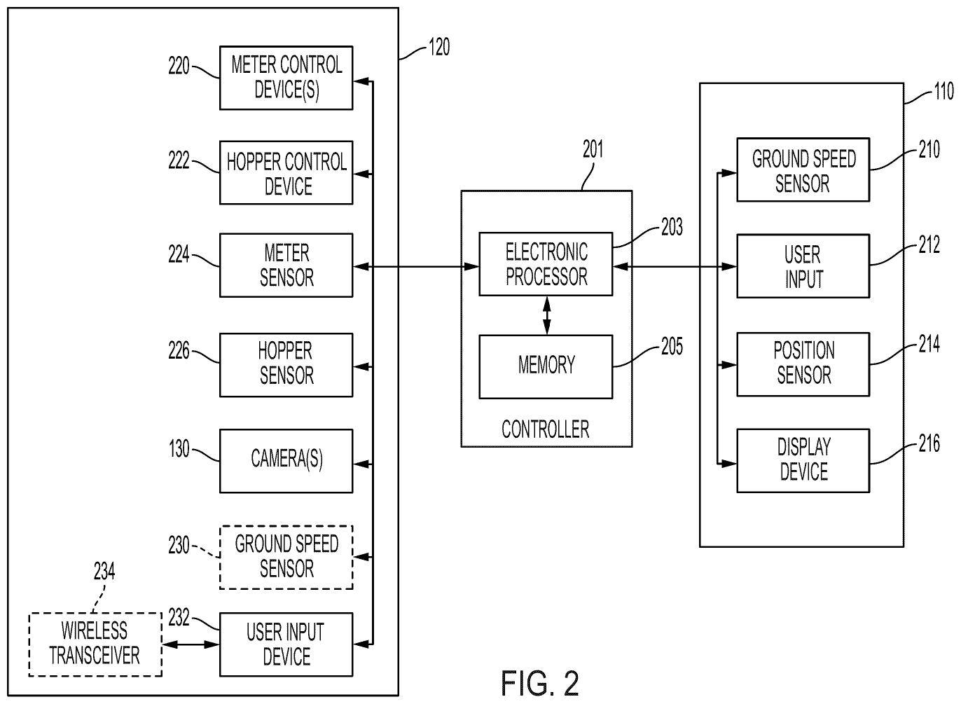

FIG. 2 illustrates an example of a control system configured to 1) measure the current seed feed rate of a planting machine in real time (e.g., in mass/area, lbs./area, billets/length, eyes/area, eyes/length or lbs./length), 2) compare the measured seed feed rate to a desired seed feed rate range (e.g., input by the user), and 3) calculate and output one or more adjustments to the planting parameters of the planting machine 120 in response thereto. The system includes one or more controllers 201, each of which include an electronic processor 203 and a non-transitory, computer-readable memory 205. The memory 205 is communicatively coupled to the processor 203 and is configured to store data and instructions that, when executed by the processor 203, cause the controller 201 to perform functionality such as described herein. The controller 201 is also communicatively coupled to the tractor 110 and the planting machine 120. The controller 201 can be physically mounted to the planting machine 120 or, in some implementations, provided as a remotely located computer system or server configured to wirelessly communicate with a local controller of the planting machine 120, the tractor 110, and/or other individual components of the planting machine 120 and the tractor 110. In some implementations, the functionality of the controller 201 as described herein may be distributed between multiple different controllers including, for example, one or more local controllers and one or more remote computer systems (e.g., a remote server computer) in wireless communication with each other.

In other embodiments, a plurality of controllers 201 may be present to allow individual sub-segments of the planting machine 120 to be monitored and controlled independently. For example, in instances where the planting machine 120 is able to output crop material to multiple rows simultaneously, the above-described control system may be sub-divided such that each row will be monitored and controlled independently (e.g., each row will have a dedicated camera and control system with controller 201). More specifically, in instances where a multi-row planter has completely independent systems (e.g., a dedicated hopper 121, meter device 124, and/or a planting chute 122) all systems may be controlled independently by a dedicated control device. In other embodiments where one or more of the aspects of the multi-row planter are shared (e.g., a common hopper 121, meter device 124, and/or planting chutes 122) the controller 201 and control device may be configured to arbitrate the commands sent to the shared elements to maximize the crop seed rate for all effected rows. For example, in instances where multiple planting chutes 122 share a common meter device 124, in instances where more crop material is needed for one chute but the paired chute is at the desired value, the controller 201 may only increase the flow slightly (e.g., 50% of what is needed) to minimize the overall distribution offsets.

In the example of FIG. 2, the tractor 110 includes a ground speed sensor 210, a user input device 212, a position sensor 214, and a display 216. While the various sensors are discussed in detail herein, it is understood that other forms of sensors mounted in different locations may also be used to collect similar information and data types. Furthermore, while the below sensors are physical in nature, it is understood that in other embodiments virtual sensors or models may also be used to detect or model the data or information needed.

The ground speed sensor 210 of the tractor 110 is a non-contact transducer configured to measure a ground speed of the tractor 110. The position sensor 214 (e.g., GPS system) is configured to determine a geospatial location of the tractor 110. In some embodiments, the position sensor 214 is configured to determine a speed of travel of the tractor 110 in place of or to supplement the speed sensor 210.

The input device 212 of the tractor 110 is a device configured to allow a user of the tractor 110 to provide data and control signals to a computing system (e.g., the tractor 110 or the planting machine 120). The display device 216 (e.g., a liquid crystal display [LCD]) is configured to output data in text and/or graphical format. In some embodiments, the display 216 includes the input device 212 (e.g., graphical user interface), which is displayed to a user to provide a touch-sensitive display unit.

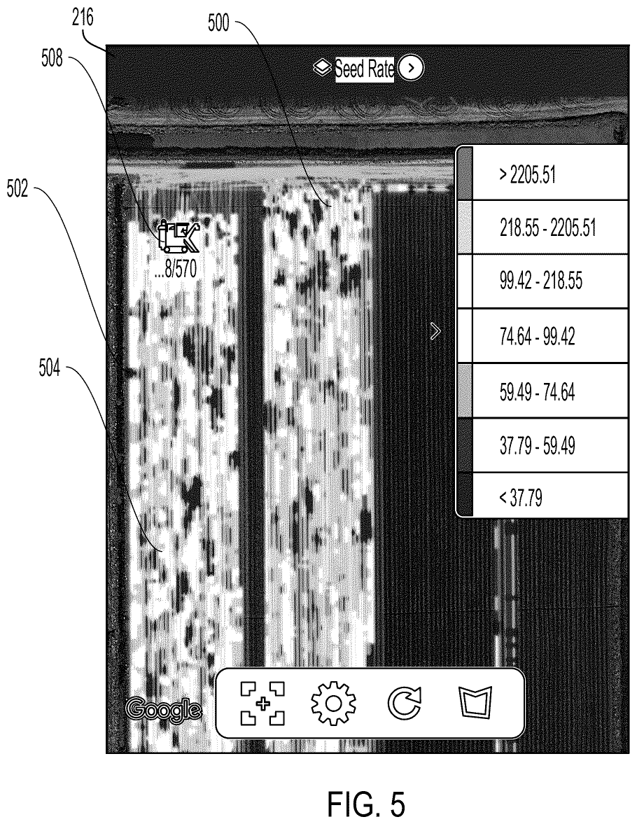

In some embodiments, the display 216 may also may also include a map overlay 500 (see FIG. 5). The map overlay 500 may include a visual representation of various crop data points 502 overlaid onto a map 504 of the corresponding field or group of fields being worked. Such data points 502 may be updated in real-time (e.g., depicting the current status of the field) and/or predictive in nature (e.g., showing the target values based on past data). The overlay 500 may also include indicia 508 representing the location of other features on the field such as, but not limited to, the planting machine 120, and the like. During use, the map overlay 500 may be used to make data driven argonomic decisions for future seed rates based on crop yield to improve on high production regions or to improve on low production yield rates.

In one embodiment, the overlay 500 may include indicia 502 indicating the current calculated crop seed rate at their corresponding locations over all or a portion of the field (e.g., a given pixel or datapoint will indicate by color, shade, brightness, and/or symbol the current calculated crop seed rate at a specific point on the field). By doing so, the user is able to quickly identify the manner in which crop seed is being distributed on the filed itself and address any abnormalities (e.g., to add more crop seed to areas having low crop seed rates, and the like). In such an embodiment, the map overlay 500 may include different colors representing different calculated crop seed rates.

In another embodiment, the map overlay 500 may include indicia indicating the desired crop seed rate at a relevant location over all or a portion of the field based on past data collected from past harvests and the like. In such an embodiment, past crop seed rates and past crop yield data may be entered into one or more algorithms to determine what the ideal crop seed rate is for a given location of the field or fields to be worked. These target or ideal crop seed rates may then be depicted on the map overlay 500 to assist the user and/or controller to set the crop distribution rates for the various areas of the field. When doing so, a given pixel or datapoint 502 may indicate by color, shade, brightness, and/or symbol the target crop seed rate for a given specific point on the field.

In the example of FIG. 2, the planting machine 120 includes a meter control device 220, a hopper control device 222, a meter sensor 224, a hopper sensor 226, a camera 228, and a user input device 232. While the various sensors are discussed in detail herein, it is understood that other forms of sensors mounted in different locations may also be used to collect similar information and data types. Furthermore, while the below sensors are physical in nature, it is understood that in other embodiments virtual sensors or models may also be used to detect or model the data or information needed.

The meter control device 220 of the planting machine 120 is configured to control a rate that the meter device 124 provides crop material to the planting chute 122. For example, the meter control device 220 can increase or decrease a meter dispense rate (e.g., final metering rate) of the meter device 124 by increasing or decreasing the motor speed of the meter device 124. In another example, the meter control device 220 can increase or decrease a meter dispense rate (e.g., final metering rate) of the meter device 124 by controlling one or more actuators that open or close a control valve of the meter device 124 that increases or decreases a speed of a flow of crop material into the planting chute 122.

The hopper control device 222 of the planting machine 120 is configured to control a rate that the hopper 121 provides crop material to the meter device 124. For example, the meter control device 220 can increase or decrease a crop material feed rate of the hopper 121 (e.g., billet feed rate) to the meter device 124. In this example, the hopper control device 222 can increase or decrease the crop material feed rate from the hopper 121 to the meter device 124 by controlling one or more actuators that open or close a control valve of the hopper 121 that increases or decreases flow of crop material to the meter device 124. In some embodiments, the meter control device 220 and the hopper control device 222 are adjusted based at least partially on a yield value (e.g., measured or estimated) and/or a target seed rate of the planting machine 120 (described below). A seed rate is an amount of crop material deposited on the surface of the field over a given area. Depending on the crop being deposited, the feed rate may be measured in different ways such as, but not limited to, billet nodes per meter, billet eyes per meter, billet nodes per acre, billet eyes per acre, tons of crop material per meter, tons of material per acre, individual plants per acre, and the like.

The meter sensor 224 of the planting machine 120 is a non-contact transducer configured to measure a volume of crop material that is being discharged from the meter device 124 at a measurement location during metering or advancement from the meter device 124 to the planting chute 122. In some embodiments, the meter sensor 224 may indirectly measure the volume of crop material by monitoring one or more operating conditions of the meter device 124 itself. For example, the meter sensor 224 may detect and output signals indicative of a speed of a metering wheel driven by a meter motor (e.g., a hydraulic motor) of the meter device 124 using a shaft encoder on the shaft that drives the meter device 124.

The hopper sensor 226 of the planting machine 120 is configured to output signals indicative of the volume of crop material stored in the hopper 121 at any given period in time. In the illustrated embodiment, the hopper sensor 225 is a weight transducer that measures and converts a weight of crop material placed in the hopper 121 into an electrical output signal whereby the controller 201 is able to calculate the volume of crop material therein. In other embodiments, the hopper sensor 226 may include one or more cameras configured to visually detect the volume of crop materials stored in the hopper 121.

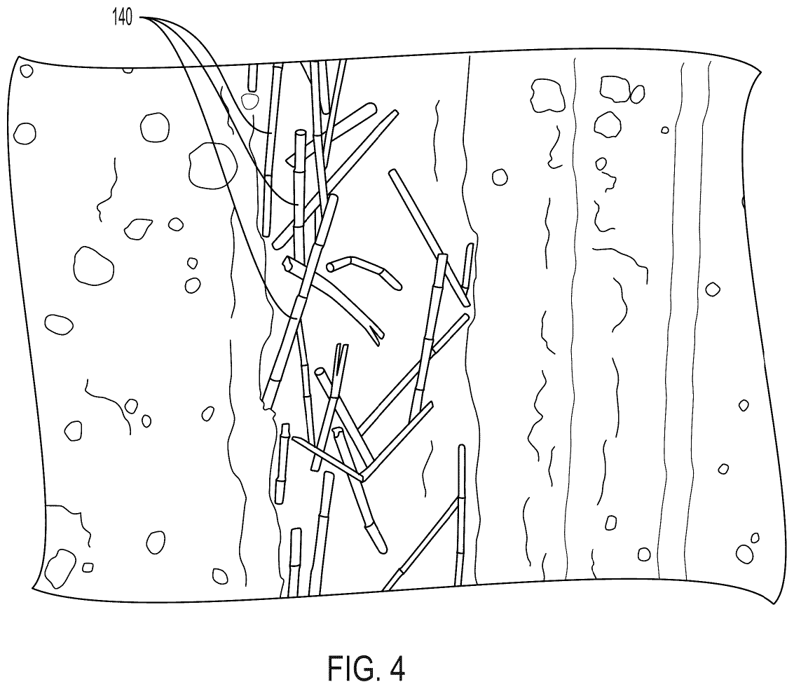

The one or more cameras 130 of the planting machine are each configured to output video data of a pre-determined field-of-view during operation of the planting machine 120 (see FIG. 4). For example, the camera 130 may include a stereo camera that captures a three-dimensional (3D) image of the target area and outputs a signal to the controller 201 of the same. The camera 228 can be mounted in various locations on the planting machine 120 for establishing the field-of-view in different locations, such as on the planting chute 122 (e.g., camera 130-1), the meter device 124 (e.g., camera 130-2), on the ground (e.g., camera 130-3; in the area where the crop material is initially deposited), and the like. Generally speaking, the cameras 130 may be placed in any position where all or a portion of the flow of crop material passes during the planting process (discussed above). While the above cameras 130 are described as 3D stereo cameras outputting signals representative of the three-dimensional state of the field of view, it is understood that in other embodiments the cameras 130 may be traditional two-dimensional cameras outputting signals representative of a two-dimensional image of the field of view.

For example, a camera 130 may be positioned so that a field of view includes a target region or region of interest where crop material is fed into the meter device 124 or the planting chute 124. In such examples, the camera 130 can capture and relay an image (e.g., color, shape, texture, etc.) of the crop material flowing through the field of view of the camera 130. In still other embodiments, the camera 130 may be configured to capture video data of a target region (e.g., of the planting chute 122) when a corresponding sensor (e.g., the hopper sensor 226, meter sensor 224, non-contact transducer, and the like) indicates that crop material is being provided. By doing so, the system is able to assure that the camera 130 is operating whenever crop material is present which ensures precise repeatability and operation during metering and crop advancement from the hopper 121. As a result, the camera 228 does not collect erroneous data for locations where planting is not occurring.

The user input device 232 is a device configured to allow a user of the planting machine 120 to provide data and control signals to the system. In some embodiments, the user input device 232 is configured to communicate wireless with a remote device or server. In other embodiments, the planting machine 120 may include a ground speed sensor 230 configured to measure the ground speed of the planting machine 120. In some embodiments, the planting machine 120 may include a wireless transceiver 234 (e.g., a wi-fi, RF, or other wireless transceiver).

As illustrated in FIG. 2, the controller 201 is communicatively coupled to a plurality of different sensors and devices of the tractor 110 and the planting machine 120. The controller 201 is configured to receive an output signal from each of these sensors and devices through one or more wired or wireless interfaces. In some implementations, the controller 201 is configured to receive the output signal from one or more of the sensors and devices directly and, in some implementations, the controller 201 is coupled to one or more of the sensors and devices via a controller area network (CAN) bus and is configured to receive the output signals from the one or more sensors and devices via the CAN bus.

In the example of FIG. 2, aspects and features of the present disclosure relate to a system using a unique combination of video camera hardware and image processing algorithms to identify and measure, in real time, either directly or predicted through calculations, the number of eyes 145 or nodes 141 that have been deposited on the ground over a pre-determined area (e.g., the seed feed rate). More specifically, crop material is provided to the meter device 124 and/or dropped into the planting chute 122 where it is observed passing through a target or region of interest where the crop material (e.g., billets 140) are viewed, monitored, and seed feed rate is calculated. In some embodiments, the controller 201 includes an image processing module that includes a processor and memory, the memory including a machine learning algorithm and/or artificial intelligence engine to perform a machine vision task (e.g., object counting, object detection, object identification). For example, the memory may include a trained support vector machine, neural network (e.g., convolution neural network), etc.

In some embodiments, the controller 201 receives corresponding images of a target region from the camera(s) 130 that include the crop material and generates a 3-D image of the planting chute 122 and/or the crop material passing through the target area of the chute 122. In this example, the controller 201 identifies a unique matching pixel for each pixel on the first camera lens to the second camera lens of the camera(s) 228 to generate 3-D topological map of the crop material. In some implementations, the controller 201 filters the 3-D map to remove noise and erroneous data.

During use, the system is configured to calculate the seed feed rate of the planting machine 120 as it travels along the field or surface in real time. More specifically, the controller 201 is configured to receive a stream of data from the one or more cameras 130 mounted to the planter 120, identify and/or calculate the number of eyes 145 present on the billets 140 that have been deposited, and combine the eye 145 data with the location data to determine the seed feed rate over the traversed area (e.g., eyes per acre and/or eyes per meter).

To measure the number of eyes 145 present, the controller 201 is configured to input the information collected from the one or more cameras 130 into one or more algorithms whereby the algorithms are able to visually identify and count the features on individual billets 140 as they pass through the corresponding field-of-view. Once a billet 140 is identified, the controller 201 is configured to either directly measure the number of eyes 145 present in the identified billet 140 or calculate the estimated number of eyes 145 present in the identified billet 140. To measure the eyes 145 directly, the controller 201 may use a number of different techniques. In one example, the algorithms may have the accuracy to visually identify each eye 145 directly. In other embodiments, the controller 201 may instead count the number of nodes 141—which are much more easily identifiable on a billet 140 than the eye 145 itself and use calculations to determine how many eyes 145 are present. More specifically, the controller 201 may assume that each node 141 includes an eye 145 to form a 1:1 ratio. In other embodiments, the controller 201 may assume that a different percentage (e.g., 85%, 90%, and the like) of nodes 141 identified can be counted as an eye 145.

In instances where individual billets 140 cannot be seen by the cameras or are fully or partially obscured, the controller 201 may calculate an estimated number of eyes 145 associated with each billet 140. To do so, the controller may rely on bulk billet statistic collected from all visible billets 140 and apply the data to the obscured billet. In still other embodiments, the controller 201 may build a virtual billet model based on past collected data and apply what attributes can be determined to the model. For example, if the controller 201—via the camera data—is only able to determine that 1) a billet 140 exists and 2) what the overall length of the billet is. The controller 201 may be configured to use a combination of billet parameters (e.g., average bulk internodal distance, average bulk billet age, average billet number, etc.) to calculate how many nodes 141 (and as a result eyes 145) should be located on the obscured billet 140 for its given length. In another example, if only the presence of the billet 140 can be determined by the camera data, the controller 201 may rely on the average bulk number of eyes 145 per billet 140 and merely attribute that number to the billet 140 for the purposes of the seed feed rate calculations. As shown above, the algorithms are configured so that they can incorporate more and more information into the bulk characteristics and/or virtual billet model when available. By doing so, the controller 201 is able to maximize the accuracy of the calculations so that estimates are 1) only used when necessary, and 2) when used are only assuming as little information about the billet 140 as possible. Furthermore, the algorithms are configured so that they can continuously update the bulk characteristics and virtual billet model as more billets 140 are detected and recorded.

Still further, the controller 201 may also be configured to detect and/or calculate the presence of billets 140 that have not been visually located by the cameras 130 at all. For example, in instances where the depth, width, and cross-sectional shape of the area where the billets are traveling is known, the controller 201 may be configured to model how many billets 140 it believes to be present that are completely obscured. Such a number may be generated based on the number of billets 140 that are visible and the individual billet attributes of those billets 140. Furthermore, after calculating the number of billets 140 believed to be present but not visible, the controller 201 may then calculate the estimated number of eyes 145 present on each fully obscured billet 140 as discussed above.

In some embodiments, the controller 201 may receive an image of a video output of the camera(s) 228 and generates a 3-D image of the crop material flowing into a target region of the planting chute 122. The controller 201 then determines a seed rate of the crop material in the field of view of the camera(s) 130. For example, the controller utilizes the physical appearance of the crop material to determine an amount (e.g., number) of the billets 140 in a target region as discussed above. In some implementations, the crop seed rate is determined based at least in part the number of detected/calculated nodes 141, internodes 143, and/or eyes 145 in the target region. In another example, the controller 201 determines the crop seed rate based on a measurement of the crop material in a target region and the type of the billet 140. The controller 201 can also estimate billet seed rate information (e.g., number of billets 140, nodes 141, and eyes 145) for a portion of an image that has degraded image quality. The estimation may be determined based on the type of the billet 140 identified in the image, and/or the bulk billet information that has been calculated for various sub-groups of crop material that have already been planted.

In some embodiments, the controller 201 may determine the seed feed rate of the crop material in a target region associated the field of view of the camera(s) 130 based at least in part on the weight associated with the crop material. In such embodiments, the controller 302 can determine a density of crop material based on a weight from the hopper sensor 226 of the crop material that is loaded into the planting machine 120 prior to performing planting operation. In some embodiments, the controller 201 determines a density of the crop material based on pre-operation crop material weight of the planter, a current crop material weight, and a defined distance and/or speed travelled of the planting machine 120. More specifically, the controller 201 will calculate the weight of crop material that has been deposited (subtracting the current hopper weight from the initial hopper weight) and use pre-determined crop models to determine the expected crop yield for a given weight of material. To improve the accuracy of such calculations, the controller may take into account additional information beyond the weight including, past crop statistics from the same or similar regions, pre-collected crop statistics based on the type or species of plants being planted, the age of the crop that was used to form the crop material in the hopper, statistics formed from taking samples of the crop material in the hopper, and the like.

In still other embodiments, the controller 201 may calculate the seed rate of the planting machine 120 based at least in part on video data of the camera(s) 130 and operating parameters of the planting machine 120. Operating parameters can be received by the controller 201 through a CAN bus connection to the planting machine and the tractor 110. For example, the operating parameters include ground speed, GPS location, and machine status (e.g., meter speed, crop material weight). In some embodiments, the controller 201 determines an instantaneous volume of crop material of a target region using video data from the camera(s). The controller 201 combines the determined volume with a meter speed of the meter device 124 to produce a volume estimate of the crop material planted. For example, the controller 201 determines a yield measurement by integrating the volume estimate with machine operating parameters, such as ground speed, GPS location, and machine status. In some embodiments, the controller 201 converts the determined yield to a yield weight estimate by multiplying an estimated volume of crop material of a target region with an estimate of the density of the crop material. In some implementations, the volume determined using the video data of the camera(s) 228 include a volume of the billets 140, the count of the eyes 145, and/or the nodes 141 per billet 140, which the controller 201 converts to a node per meter metric.

In yet another embodiment, the controller 201 may determine the seed feed rate of the planting machine 120 by integrating the instantaneous volume measurement with a speed input and a time difference to determine a total volume of crop material flowing out the planting chute 122 (e.g., a total yield or seed rate).

In some embodiments, the controller 201 may further collect the calculated seed feed rate statistics and corresponding locations of the planting machine 120 to generate a map of the planted crop material to be displayed to the user. The controller 201 creates an overlay using geospatial locations of the planting machine 120 and topological map of the field surface. Each location of the overlay corresponds to a location of the field surface and includes planting metrics (e.g., yield) for each location. Additionally, the controller 201 provides the overlay to the display device 216. In some implementations, the yield map is generated as a “spreadsheet”-type format including a listing of geospatial locations and a corresponding yield value for each geospatial location. The yield map may then be displayed (e.g., on the display device 216) either textually (as a listing of yield values for each geospatial location) or graphically (e.g., using color-coding to indicate different yield values for each different geospatial location on a two- or three-dimensional representation of the field surface).

After the current seed feed rate has been calculated as discussed above, the controller 201 may then generate a recommendation to modify one or more operating conditions of the planting machine 120 based at least partially thereon. More specifically, the controller 201 is configured to compare the calculated seed feed rate to the desired seed feed rate window and output a set of recommendations in view thereof. In the illustrated embodiment, the controller 102 may modify any combination of a dispense rate of the meter device 124, a feed rate of the hopper 121, and/or the travel speed of the tractor110. More specifically, when the calculated seed feed rate exceeds the desired range, the controller 201 either automatically or through suggested changes attempts to reduce generally reduce the feed rate of the hopper and/or the meter device or increases the travel speed. In contrast, if the calculated seed feed rate is less than the desire range, the controller 201 either automatically or through suggested changes attempts to increase the feed rate of the hopper and/or the meter device or decreases the travel speed. Combinations of the above may also be suggested.

In some embodiments, the seed feed rate threshold can include a density threshold and/or a volume threshold. In some implementations, the controller 201 determines that the planting machine 120 exceeds a density threshold and generates a recommendation to modify a billet feed rate of the hopper 121. For example, the density threshold can be based on a weight of the crop material stored in the hopper 121 and distance traveled by the planting machine 120. Additionally, the density threshold indicates whether the hopper 121 has too much or too little crop material to achieve the target planting rate for a defined area of the field surface. In other implementation, the controller 201 determines that the planting machine 120 exceeds a volume threshold and generates a recommendation to modify a dispense rate of the meter device 124. For example, the volume threshold can be based on a count information of the crop material in a target region of the planting chute 122 and distance traveled by the planting machine 120. Additionally, the volume threshold indicates whether the meter device 124 is dispensing too much or too little crop material into the planting chute 122 to achieve the target planting rate for the field surface. In some embodiments, the controller 201 provides a recommendation to the display device 216. In some embodiments, the recommendation includes a speed modification to the tractor 110 when the settings for the hopper 121 and the meter device 124 are constant.

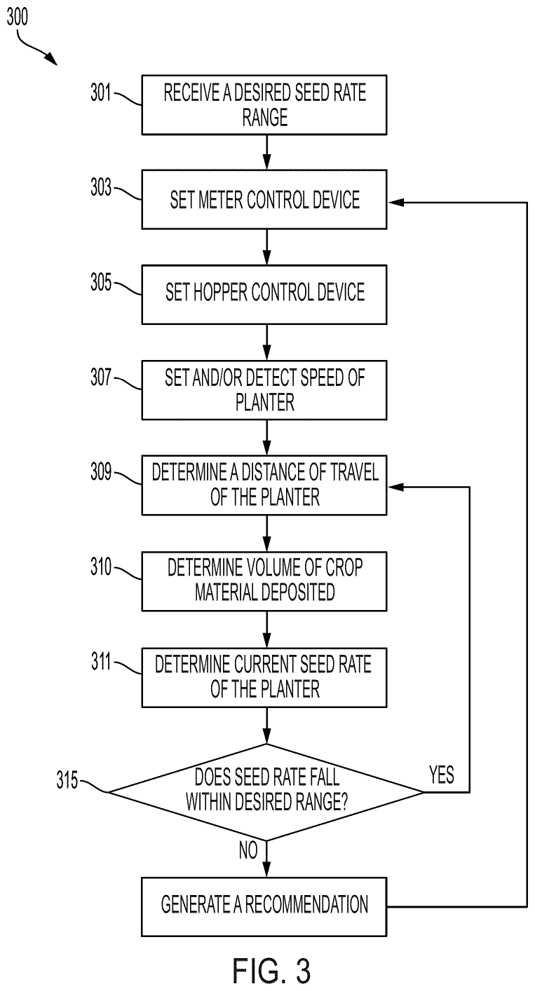

FIG. 3 is an example of a method in which the controller 201 facilitates measuring seed feed rate of a planting machine 120 and managing the operating parameters of the planting machine, according to implementations in the present disclosure. The controller 201 receives a target seed feed rate from the user input 212 of the tractor 110 (step 301). In some implementations, the controller 201 receives a user selection associated with the target seed feed rate from the user input 212. The user selection includes a seed feed rate in relation to time and or distance.

In response to the desired seed feed rate, the controller 201 sets the meter control device 220 of the planting machine 120 to a first feed rate (step 303). In some implementations, the controller 201 configures an initial set point of the meter control device 220 based on a seed rate associated with the target planting rate provided by a user. The initial set point is associated with a position of a control valve of the meter control device 220 that drives a motor of the meter device 124 at predetermined speed.

The controller 201 also sets the hopper control device 222 of the planting machine 120 to a first feed rate (step 305). In some implementations, the controller 201 configures an initial set point of the hopper control device 222 based on a seed rate associated with the target planting rate provided by a user. The initial set point is associated with a position of a control valve of the hopper control device 222 that controls a flow of crop material from the hopper 121 to the meter device 124 at predetermined rate.

The controller 201 then sets and/or detects a speed associated with the planting machine 120 (step 307). In some implementations, the controller 201 utilizes the electronic processor 203 to determine a speed of the planting machine 120 based on a signal from the ground speed sensor 210 of the tractor 110, which is coupled to the planting machine 120. Alternatively, the controller 201 can determine a speed of the planting machine 120 based on a signal from the position sensor 214 using a distance traveled by the tractor 110 over a defined period of time. In other implementations, the controller 201 utilizes the electronic processor 203 to determine a speed of the planting machine 120 based on a signal from the ground speed sensor 230 of the planting machine 120. In some embodiments, the controller 201 determines a speed of the meter device 124. For example, the controller 201 receives a signal from the meter sensor 224 and utilizes the electronic processor 203 to determine a speed of the meter device 124. In still other embodiments, the controller 201 may actually output a desired travel speed or actually control the speed of the tractor 110 directly.

The controller 201 then determines a distance travelled by the planting machine 120 (step 309). In some implementations, the controller 201 receives from the position sensor 214, one or more geospatial locations associated with a path driven by the tractor 110. The controller 201 utilizes the electronic processor 203 to determine a distance traveled of the planting machine 120 based on the one or more geospatial locations of the tractor 110, which is coupled to the planting machine 120. The controller 201 is configured to store the one or more geospatial locations in the memory 205.

The controller 201 determines a volume of crop material deposited over the travel distance (step 310). As discussed above, the controller 201 receives video data from the camera(s) 130 which, via one or more algorithms, is used to directly record and/or calculate the total number of eyes 145 have been deposited onto the ground by the planting machine 120.

With both the distance of travel and volume of crop material determined, the controller 201 may then determine a seed rate of the planting machine 120 (step 311). To do so, the controller 201 combines the crop volume and travel distance information together to determine the number of eyes 145 per unit area (e.g., eyes per meter and/or eyes per acre).

The controller 201 determines whether the calculated seed feed rate falls within the desired seed feed rate range. If so, the controller 201 continues to continuously monitor and update the seed feed rate as the planter 120 continues to travel (see steps 309, 310, 311, 315). If the calculated seed feed rate falls outside the desired range, the controller 201 is then configured to calculate a desired set of operating parameters (e.g., meter control feed rate, hopper feed rate, travel speed) to adjust the current feed rate as desired. With the new parameters provided, the user then proceeds through steps 303, 305 and 307 to modify the actual operating conditions (either manually or automatically) whereby the cycle starts anew.

Accordingly, the systems and methods described in this disclosure provide, among other things, a closed-loop crop yield measurement mechanism of a planting machine that concurrently tracks and maps planting quality of the planting machine. Other features and advantages are set forth in the following claims.

What is claimed is:

1. A system for measuring crop seed rate of a planting machine, the system comprising:
a camera having a first field of view through which crop material may pass; and
one or more electronic controllers in operable communication with the camera and the planting machine, where the electronic controllers are configured to:
receive image data from the camera,
identify one or more attributes of the crop material positioned in the field of view of the camera,
determine a speed associated with the planting machine,
determine a current crop seed rate of the planting machine based at least in part on the one or more attributes of the crop material in the field of view and the speed of the planting machine, and
output one or more recommended operating conditions to the planting machine based at least in part on the determined crop seed rate.

2. The system of claim 1, wherein identifying one or more attributes of the crop material includes identifying at least one of the number of billets in the field of view, the number of nodes in the field of view, and the number of eyes in the field of view.

3. The system of claim 1, wherein the one or more electronic controllers compare the current crop seed rate to a target crop seed rate to determine a crop seed rate difference, and wherein the one or more electronic controllers output the one or more recommended operating conditions based at least in part on the crop seed rate difference.

4. The system of claim 1, wherein the one or more controllers have memory, wherein the one or more controllers store past crop seed rate data in the memory, and wherein the one or more controllers determine the current crop seed rate based at least in part on the past crop seed rate data.

5. The system of claim 1, wherein outputting one or more recommended operating conditions to the planting machine includes outputting a suggested travel speed.

6. The system of claim 1, wherein the one or more electronic controllers collect location data associated with a path the planter traverses in a defined area, and
generates an overlay for a map of the defined area based on the location data, the seed feed rate of the planting machine, and the amount of nodes.

7. The system of claim 1, further comprising a second camera having a second field of view, and wherein the one or more controllers are in operable communication with the second camera.

8. The system of claim 7, wherein the first camera and the second camera produce a three-dimensional image.

9. A method for measuring seed feed rate of a planting machine, the method comprising:
receiving image data from a camera of a planting machine, the image data including an image of a crop material in a target region of the planting machine;
receiving a target seed feed rate from one of memory and the user;
determining an attribute associated with the crop material in the target region of the planter;
determining a travel speed associated with the planting machine;
determining a current seed feed rate of the planting machine based on the attribute associated with the crop material in the target region and the speed associated with the planting machine; and
transmitting one or more target operating conditions to the planting machine based at least in part on the current seed feed rate and the target seed feed rate.

10. The method of claim 9, wherein transmitting one or more target operating conditions includes transmitting a target travel speed.

11. The method of claim 9, wherein receiving image data from a camera includes receiving three-dimensional image data.

12. The method of claim 9, wherein determining an attribute associate with the crop material in the target region includes at least one of determining the number of billets present in the target region, determining the number of nodes in the target region, and determining the number of eyes in the target region.

13. The method of claim 9, wherein determining an attribute associate with the crop material in the target region includes determining one or more attributes of an individual billet within the target region.

14. The method of claim 13, wherein determining one or more attributes of an individual billet includes determining at least one of the billet length, the number of nodes on the billet, and the number of eyes on the billet.

15. The method of claim 13, wherein determining one or more attributes of an individual billet includes calculating the attribute based at least in part on a pre-determined virtual billet model.

16. The method of claim 9, further comprising calculating one or more bulk billet attributes based at least in part on the attributes associated with the crop material in the target region.

17. The method of claim 16, wherein determining the current seed feed rate is at least partially dependent upon the bulk billet attributes.

18. The method of claim 9, wherein transmitting one or more target operating conditions includes increasing and decreasing the seed distribution rate.

19. A planting machine comprising:
a hopper;
a planting chute;
a metering device configured to output crop material at a pre-determined rate to the planting chute;
a camera having a first field of view configured to capture crop material that is distributed from the metering device; and
one or more controllers in operable communication with the hopper, planting chute, metering deice, and camera, wherein the controller:
receives video data from the camera,
identifies one or more attributes of the crop material traveling through the first field of view,
calculates the travel speed of the planting machine,
calculates the crop seed rate of the planting machine based at least in part on the travel speed and one or more attributes of the crop material, and
outputs commands to the metering device to increase or decrease the pre-determined rate based at least in part on the calculated crop seed rate.

20. The planting machine of 19, wherein he one or more attributes of the crop material may include the number of billets present, the number of nodes present, and the number of eyes present.
